(19) United States
(12) Patent Application Publication
(10) Pub. No.: US 2015/0275835 A1
(43) Pub. Date: Oct. 1, 2015

(54) INJECTOR WITH INCREASED FLOW CROSS-SECTION

(71) Applicant: Liebherr Machines Bulle SA, Bulle (CH)

(72) Inventor: Waldemar Hampel, Bulle (CH)

(21) Appl. No.: 14/668,581

(22) Filed: Mar. 25, 2015

(30) Foreign Application Priority Data
Mar. 25, 2014 (CH) 0045414

(51) Int. Cl. F02M 61/08; F02M 51/06

(52) U.S. Cl. CPC F02M 61/08; F02M 51/06

(57) ABSTRACT

Methods and systems are provided for a fuel injector. In one example, a system may include an injector with a first, non-linear wall and a second-non-linear wall defining one or more flow ducts of an injector.

### CROSS REFERENCE TO RELATED APPLICATION

This application claims priority to Swiss Patent Application No. 0045414, entitled “Injector with Increased Flow Cross-Section”, filed Mar. 25, 2014, which is hereby incorporated by reference in its entirety for all purposes.

### TECHNICAL FIELD

The present disclosure relates to an injector of an internal combustion engine.

### BACKGROUND AND SUMMARY

For example in internal combustion engines, injectors are used to inject fuels into combustion chambers. In a usual construction, a needle is shiftably mounted in a nozzle. In a closed state of the injector, at least one nozzle orifice of the nozzle can be closed by the needle or by a part of the needle. In another state, the needle can clear the at least one nozzle orifice of the nozzle for a fuel flow.

The fuel guidance within the nozzle can be effected for example through a bore hole in a cannulated needle. The fuel can, however, also be guided through a guideway located above a flow cross-section, which is specified corresponding to a given injector concept. It also is common practice to guide a laterally flattened needle for example as triple flat or quadruple flat within a nozzle. Other examples include increasing the guideway diameter or the diameter of a cutout within the nozzle in order to obtain greater flow areas or flow cross-sections, and thereby provide greater fuel flows with lower pressure losses.

However, the inventors herein have recognized potential issues with such systems. As one example, the outside dimensions or dimensions of the entire component are increased disadvantageously and cause increased seat wear of the injector. This wear is largely due to a relatively high impact energy of the nozzle needle onto the nozzle. The closing velocity of the needle or the injector must not be reduced, however, for technical reasons.

In one example, the issues described above may be addressed by an injector with a nozzle and needle, where the needle is shiftable mounted in a cutout of the nozzle. The nozzle and needle further comprising at least one flow duct defined by at least two non-planar boundary walls. In this way, the injector may provide lower seat wear and improved flow behavior. In one example, this is achieved without increasing an outer dimension of the fuel injector.

The flow cross-section between nozzle needle or needle and nozzle is increased due to the non-planar design of both boundary walls. A first boundary wall is a side face of the needle and a second boundary wall may be part of the inner wall of the cutout. In this way, the pressure loss between a fuel accumulator or a fuel pump and the needle seat or the nozzle orifice is minimized. Further benefits may be gained by designing the first boundary wall such that as much material as possible is removed from the needle in order to make the needle more lightweight. By reducing the weight of the needle, seat wear may be improved.

In one embodiment, more than one flow duct may be provided between the nozzle and the needle. For example, it can be provided that exactly three flow ducts are provided between nozzle and needle.

In a second embodiment, additionally or alternatively, the first non-planar boundary wall of the at least one flow duct may be part of the needle and/or that the second non-planar boundary wall of the at least one flow duct may be part of the inner wall of the cutout.

The at least one flow duct thus extends between the two non-planar boundary walls. The non-planar design in particular of the first boundary wall increases the flow cross-section of the flow duct in particular in comparison with a planar first boundary wall.

In a third embodiment, additionally or alternatively, the cutout may be cylindrical. Manufacturing of the cylindrical cutout and the needle guided in the cutout of the nozzle with a corresponding fit may be easy and cost-effective to manufacture.

In a fourth embodiment, additionally or alternatively, the boundary walls may have a concave shape. Manufacturing of the boundary walls with a concave shape may also prove to be easy and cost-effective to manufacture.

In a fifth embodiment, additionally or alternatively, at least one cross-section of the first boundary wall substantially may have the shape of a circular arc. The circular-arc shape of the cross-section of the first boundary wall is substantially the same along its entire or almost entire length. Therefore, the manufacturing process of the first boundary wall is further simplified.

In a sixth embodiment, additionally or alternatively, the shape of at least one flow duct corresponds to the shape of two cylinder portions put together flush at their flat portions.

The present disclosure furthermore is directed to an internal combustion engine, in particular to a diesel engine, with at least one injector according to any of claims 1 to 7.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIGS. 1A and 1B show a top view and a side view of an injector according to the prior art.

FIGS. 2A, 2B and 2C show a top view from a first point of view, a top view from a second point of view, and a side view of an injector, respectively.

FIG. 3 shows an engine with an injector.

### DETAILED DESCRIPTION

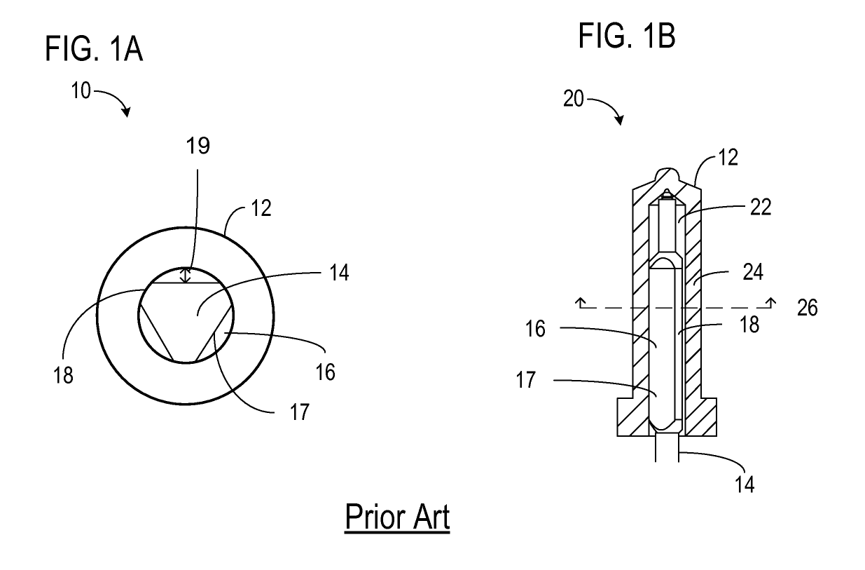

FIGS. 1A and 1B show a cross section 10 of an injector 20 and an injector 20 according to the prior art repsectively. An area of the cross section 10 along with its point of view is revealed by dashed line 26 on the injector 20 of FIG. 1B. As depicted, a needle 14 is guided in the nozzle 12 by a guiding wall 18. The needle 14 is shiftably mounted in a cutout 22 of the nozzle 12. Between nozzle 12 and needle 14 three flow ducts 16 each are shown in both the cross-section 10 and the injector 20. The flow ducts 16 according to the prior art extend between the cylindrical inner surface of the nozzle 12 and planar portions of the needle 14. Said another way, the flow ducts 16 are defined by a gap between a guiding wall 18 and a boundary wall 17, in which the boundary wall 17 is linear (e.g., straight), and not curved or arced. As depicted, portions of the needle 14 are physically coupled to guiding wall 18 with flow ducts 16 separating remaining portions of the needle 14 from guiding wall 18.

As depicted in FIG. 1B, nozzle 12 houses at least a portion of needle 14 with only a bottom portion of needle 14 protruding from outside the nozzle 12. Flow ducts 16, guiding wall 18, cutout 22, and inner wall 24 are all completely housed by nozzle 12. As described above, the needle 14 closes at least one orifice of the nozzle 12. As an example, the needle 14 may close an orifice of the guiding wall 18 when the nozzle 12 is in a closed position (e.g., fuel injection is not desired by a combustion chamber of the engine).

As depicted in the prior art, the flow ducts 16 and the needle 14 contact in a linear fashion via boundary wall 17. The only curved portion of the flow ducts 16 is the portion of the flow ducts 16 contacting the guiding wall 18. A distance 19 is equal to a greatest distance of a flow duct 16 measured from boundary wall 17 to guiding wall 18, as shown in FIG. 1A. As depicted, distance 19 is relatively small.

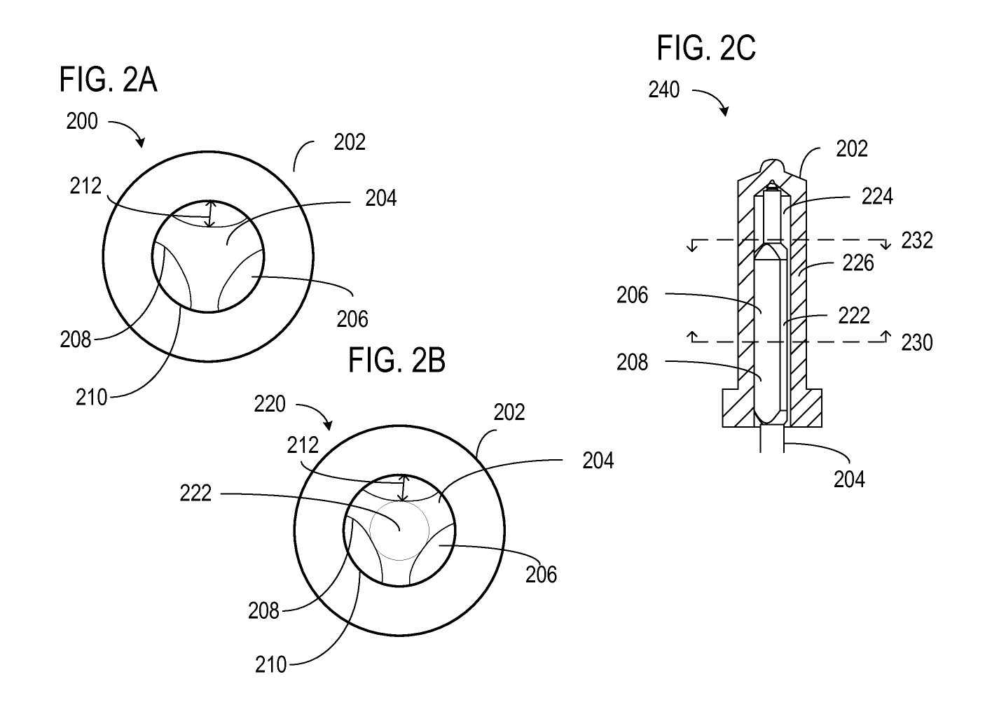

FIGS. 2A, 2B, and 2C show a first cross-section 200 of an injector , a second cross section 220 of an injector, and an injector 240, respectively. Areas of the first cross section 200 and the second cross section 220 along with their vantage points are shown by dashed lines 230 and 232, respectively, on injector 240 with respect to FIG. 2C. The description of the prior art components, with respect to FIGS. 1A and 1B, in connection with injector components described herein, with respect to FIGS. 2A, 2B, and 2C, may not be repeated but apply to the injector as well.

The first cross section 200 shows a needle 204 guided in a nozzle 202 by a second boundary wall 210. Portions of the needle 204 are physically coupled to and contiguous with the second boundary wall 210, while remaining portions of the needle 204 are separated from the second boundary wall 210 by three flow ducts 206. The three flow ducts 206 are defined by a non-linear, first boundary wall 208 and a non-linear, second boundary wall 210. The first boundary walls 208 are formed by outer surfaces of the needle 204 in a non-linear manner, as opposed to the prior art where the outer surfaces of the needle 14 are linear. First boundary wall 208 and second boundary wall 210 are concave. In this way, a distance 19 measured across a greatest distance of a flow duct 206 from a first boundary wall 208 and a second boundary wall 210 is increased compared to distance 12 of the prior art depicted in FIG. 1A. As an example, if an imaginary, linear line were drawn across a length of a flow duct 206 from a first connecting point to a second connecting point, then an area of the flow duct 206 extends on both sides of the imaginary line. Whereas, in the prior art depicted in FIG. 1A, an area of the flow duct 16 extends only on one side of an imaginary linear line (e.g., boundary wall 17) drawn across a length of a first connecting point and second connecting point. It will be appreciated by someone skilled in the art that the first boundary wall and second boundary wall may be suitable shapes to increase a flow duct area and provide one or more of the advantages listed below.

The first boundary wall 208 is a circular-arc for its entire or almost entire length as depicted in the cross section 200.

By machining the flow ducts 206 to be non-linear, an injector may obtain the advantages listed above. The flow ducts 206 may resemble the shape of two cylinder portions put together flush at their flat portions. These advantages may occur due to the increased size and/or area of the flow ducts 206, shown by distance 212, compared to the prior art flow ducts 16 with a distance 19. The advantages include an increased cross-section flow between the needle 204 and the nozzle 202 and removal of material from the needle is increased in order to lower seat wear while maintaining an area of a guiding wall. Additionally, due to the non-planar (e.g., concave) design of the boundary walls 208, 210 a greater flow area is provided for the fuel flow, which leads to less pressure loss between a non-illustrated accumulator or a fuel pump and the nozzle seat.

Turning to the second cross section 220, a guiding wall 222 is included due to the inverted vantage point portrayed in the cross section 220 compared to cross section 200. Cross section 220 illustrates a proximity of the first boundary wall 208 to a cutout 224 of the guiding wall 222. The cutout 224 of the guiding wall 222 is tangentially adjacent to the first boundary wall 208.

Turning to the injector 240 of FIG. 2C, which includes the nozzle 202 housing the needle 204 with guiding walls 222 on an outer circumference of the needle 204. Due to the concave design of the first boundary walls 208 and the second boundary wall 210, the guiding wall 222 between the components nozzle 202 and needle 204 is not reduced for wear and function reasons, while at the same time the mass of the needle 204 is decreased and the flow cross-section, which is composed of the cross-sections of the flow ducts 4, is increased, resulting in minimal costs in the manufacturing of the components. For example, an area of the guiding wall 222 is kept constant as an area of the flow ducts 206 is altered. Additionally or alternatively, the total surface area of the guiding surfaces 222 may be maintained such that the impact on manufacturing the injector 240 is relatively small.

As shown, the first boundary wall 208 extends closer to the cutout of the guiding wall 222 than the first boundary wall 17 does with cutout 22 of guiding wall 18 of the prior art shown in FIG. 1B. This may be due to a more acutely angled cut (e.g., an angular slice) of the first boundary wall 208, compared to a less acutely angled cut of first boundary wall 17, in order to give the first boundary wall 208 a concave shape. By doing this, the area of the flow ducts 206 are increased while maintaining the area of the guiding wall 222.

The needle 204 may close the cutout 224 of the guiding wall 222 when the nozzle 202 is closed. In this way, the needle is unable to inject fuel into an internal combustion engine. Alternatively, the needle 204 protrudes through the cutout 224 when the nozzle is in an open position so that the needle is capable of injecting fuel into the engine.

The second boundary walls 210 are formed by the inner wall 226 of the cutout 224 of the injector 240. As described above, the first boundary walls 208 are formed by outer surfaces of the needle 204. As depicted, the needle 204 extends through the orifice of the guiding walls 222 and the cutout 224 of the inner wall 226. The cutout 224 may be cylindrical in order to correspond to a shape of the needle 204.

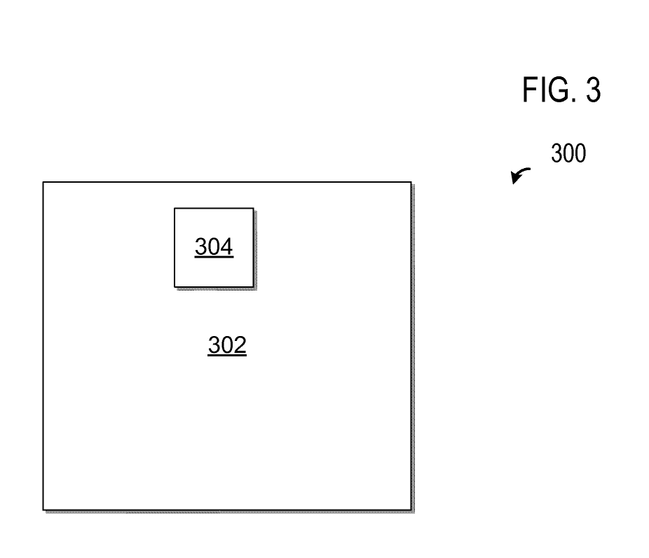

Turning now to FIG. 3, a system 300 illustrates an engine 302 with an injector 304. Injector 304 may be the same injector as injector 240 of FIG. 2C. Injector 304 may be coupled to a fuel rail along with other injectors substantially similar to injector 304. Injector 304 may be used to inject a fuel to a combustion chamber of the engine 302. The fuel(s) injected by the injector 304 may include diesel, gasoline, and ethanol. It will be appreciated by someone skilled in the art that other sufficient fuels may be injected by the injector.

The engine 302 may be a diesel engine. Additionally or alternatively, engine 302 may be a gasoline powered engine, in which case an ignition system may be included. Engine 302 may be included as part of a working machine.

A controller (not shown) may command the injector 304 based on conditions of the engine 302. For example, if the engine 302 demands a fuel injection, the controller signals the injector to open a nozzle so that a needle of the injector may inject fuel via protruding beyond a cutout of a guiding wall. As another example, if the engine 302 does not demand a fuel injection, the controller signals the injector to close a nozzle so that a needle of the injector closes a cutout of a guiding wall and is unable to inject fuel.

In this way, an injector with decreased seat wear and pressure loss is achieved via a first, non-linear boundary wall and a second, non-linear boundary wall defining one or more flow ducts of the injector. By machining non-linear walls (e.g., concave walls), an area of the flow ducts is increased and as a result, seat wear and pressure losses are decreased. Furthermore, by increasing the area of the flow duct while maintaining an area of a guiding wall, a size of the needle is decreased, which may also decreases seat wear.

The technical effect of machining concave boundary walls in a fuel injector is to improve a longevity of the fuel injector by reducing seat wear and decreasing pressure loss between the needle and a cutout of the guiding wall.

1. An injector comprising a nozzle and needle, comprising:
the nozzle with a cutout in which the needle is shiftably mounted, and wherein between the nozzle and the needle at least one flow duct is provided, wherein the flow duct is defined by at least two boundary walls, wherein both boundary walls are non-planar.

2. The injector of claim 1, wherein the first non-planar boundary wall of the at least one flow duct is part of the needle and/or the second non-planar boundary wall of the at least one flow duct is part of the inner wall of the cutout.

3. The injector of claim 1, wherein the cutout is cylindrical.

4. The injector of claim 1, wherein the boundary walls have a concave shape.

5. The injector of claim 1, wherein at least one cross-section of the first boundary wall substantially has the shape of a circular arc.

6. The injector of claim 5, wherein the circular-arc shape of the cross-section of the first boundary wall substantially is the same along its entire length.

7. The injector of claim 1, wherein the shape of the at least one flow duct corresponds to the shape of two cylinder portions put together flush at their flat portions.

8. The injector of claim 1, wherein the injector is used with a diesel engine of a working machine.

9. A internal combustion engine, comprising:
a fuel injector;
a needle housed within a nozzle of the injector; wherein at least one portion of the needle is physically coupled to a guiding wall and at least a second portion of the needle is not physically coupled to the guiding wall via a flow duct, wherein one or more flow ducts may exist; and
the flow duct is formed by a first, non-linear boundary wall and a second, non-linear boundary wall, wherein the first, non-linear boundary wall is formed by an outer surface of the needle and the second, non-linear boundary wall is formed by an inner wall of the nozzle.

10. The internal combustion engine of claim 9, wherein the first, non-linear boundary wall is a circular-arc for an entire length of the first boundary wall.

11. The internal combustion engine of claim 9, wherein the internal combustion engine is a diesel engine.

12. The internal combustion engine of claim 9, wherein the nozzle further houses the first boundary wall, the second boundary wall, the flow ducts, and the guiding wall.

13. The internal combustion engine of claim 9, wherein the guiding wall comprises a cutout where the cutout is cylindrical.

14. The internal combustion engine of claim 13, wherein the cutout and the first boundary wall are tangentially adjacent.

15. The internal combustion engine of claim 13, wherein the needle closes the cutout when the nozzle is in a closed position, and wherein the needle protrudes from the cutout when the nozzle is in an open position.

16. The internal combustion engine of claim 15, wherein the nozzle is open when an engine fuel demand is present, and where the nozzle is closed when the engine does not demand fuel.

17. The internal combustion engine of claim 9, wherein the first boundary wall and the second boundary wall are concave.

18. The internal combustion engine of claim 9, wherein a size of the guiding wall remains constant as a size of the flow ducts changes.

19. An injector, comprising:
a nozzle housing a needle; wherein
the needle comprises a first boundary wall and a second boundary wall, wherein both walls are non-planar and concave, and where flow ducts are present at each instance of a gap existing between the first boundary wall and the second boundary wall;
the needle spanning at least the first boundary wall, the second boundary wall, a guiding wall, and at least a cutout of the guiding wall; and
the needle extends beyond the cutout when the nozzle is in an open position in order to inject fuel.

20. The injector of claim 19, wherein the injector injects one or more of a diesel, gasoline, and ethanol.
